(19) United States
(12) Patent Application Publication
(10) Pub. No.: US 2008/0121643 A1
(43) Pub. Date: May 29, 2008

(54) Mitigating Hydrogen Flux Through Solid and Liquid Barrier Materials

(75) Inventors: James G. Blencoe, Harriman, TN (US); Simon L. Marshall, Oak Ridge, TN (US)

Correspondence Address: BAKER BOTTS, LLP, 910 LOUISIANA, HOUSTON, TX, 77002-4995, US

(73) Assignee: HYDROGEN DISCOVERIES, INC., Harriman, TN (US)

(21) Appl. No.: 11/852,364

(22) Filed: Sep. 10, 2007

Related U.S. Application Data
(60) Provisional application No. 60/825,167, filed on Sep. 11, 2006.
(60) Provisional application No. 60/826,660, filed on Sep. 22, 2006.
(60) Provisional application No. 60/918,767, filed on Mar. 19, 2007.
(60) Provisional application No. 60/910,684, filed on Apr. 9, 2007.

(51) Int. Cl. F17C 1/00; F16L 9/14

(52) U.S. Cl. 220/589; 220/586; 138/140; 206/6

(57) ABSTRACT

Enhanced containment, capture, transfer, and storage of hydrogen gas in sealed enclosures is achieved using multi-layered materials comprising polymer(s), metal(s), metal alloy(s) and/or metal oxide(s) that either form, line, or coat the wall(s) of the sealed enclosures. These composite materials decrease “loss” of hydrogen gas by combining equilibrium and kinetic barriers to hydrogen diffusion. Capture and separation of gaseous hydrogen permeating through the wall(s) of an enclosure is accomplished by trapping the gas in either one or more internal liquid layers, or in one or more attached, gas-tight covers. Tightly packed sets of sealed enclosures, especially pipes or tubes with one or more polymer/metal±metal oxide/liquid layers or interlayers can be placed in hydrogen “warehouses” and/or “silos” to provide seasonally firmed supplies of hydrogen gas to local or city-gate markets.

### RELATED PATENT APPLICATIONS

This application claims priority to commonly owned:
U.S. Provisional Patent Application Ser. No. 60/825,167; filed Sep. 11, 2006; entitled “Mitigating Diffusion Hydrogen Flux Through Solid and Liquid Barrier Materials,” by James G. Blencoe, and Simon Marshall;
U.S. Provisional Patent Application Ser. No. 60/826,660; filed Sep. 22, 2006; entitled “Mitigating Diffusion Hydrogen Flux Through Solid and Liquid Barrier Materials,” by James G. Blencoe, and Simon Marshall;
U.S. Provisional Patent Application Ser. No. 60/918,767; filed Mar. 19, 2007; entitled “New, Composite Polymeric/Metallic Materials and Designs for Hydrogen Pipelines,” by James G. Blencoe, Simon Marshall and Michael Naney; and
U.S. Provisional Patent Application Ser. No. 60/910,684; filed Apr. 9, 2007; entitled “New, Composite Polymeric/Metallic Materials and Designs for Hydrogen Pipelines,” by James G. Blencoe, Simon Marshall and Michael Naney;
   all of which are hereby incorporated by reference herein for all purposes.

### TECHNICAL FIELD

The present disclosure relates generally to structures for transferring and storing hydrogen gas, and more particularly, to solid and liquid barrier (e.g., hydrogen containment) materials for those structures.

### BACKGROUND

Renewable energy resources in the U.S. could satisfy most of the nation's future energy needs. However, distributed sources of domestic renewable energy—particularly those east of the Mississippi River—cannot meet the concentrated energy demands of large cities and heavy industry. The richest centralized renewable energy resources in the U.S.—wind energy in the Great Plains States, and solar energy in the American Southwest—are largely stranded; i.e., located far from population centers, with no means for energy transmission or storage. Long electric transmission lines could be built to tap these resources, but they are capital intensive, difficult to site and permit, and special financing may be required to recover transmission costs, and to earn a profit. In addition, if the transmitted electricity is produced entirely or mainly from wind or solar energy, overall system performance will be burdened by a low capacity factor (intermittency), and by the inability to store part of the energy to “smooth” or “firm” the delivery of power. For these reasons, converting the produced electricity to hydrogen, and transmitting the hydrogen through a network of pipelines, is a potentially viable alternative strategy for delivering the energy to distant markets. Building new underground pipelines has historically been easier and faster than constructing regional electric infrastructure. Moreover, large-scale electric-transmission and hydrogen-pipeline systems are comparable in capital, operating costs and maintenance costs.

Thus, it has been suggested that large-scale, on-site, electrolytic production of hydrogen, bulk storage of the produced hydrogen gas, and long-distance pipeline hydrogen transmission, can provide “seasonally firmed” renewable energy to city-gate markets. To minimize greenhouse gas emissions, and to lower the costs of gas compression, the hydrogen could be formed from water (pumped from local aquifers, or delivered to each site by pipeline) using large electrolyzers that create gaseous hydrogen at pressures as high as 1,500 pounds per square inch (psi). The resulting pressurized hydrogen gas is either directly injected into one or more pipes connected to a pipeline transmission system, or compressed to 2,000-2,500 psi for temporary storage.

Challenges for mass production of hydrogen gas in remote locations, and transmitting the hydrogen to distant points of end-use, are daunting. One of the main difficulties—long recognized and extensively studied, but still largely unresolved—is safe, efficient, and cost-effective pipeline delivery of gaseous hydrogen at pressures greater than or equal to 500 psi. Compressed to such levels, hydrogen is difficult to contain in two respects. First, due to the tiny size of its molecules, hydrogen will pass through the narrowest of passageways, which means that leakage is very difficult to prevent. Second, hydrogen readily dissolves in, and diffuses through, many of the solid materials that are commonly used to contain gases.

Most of the hydrogen produced today for commercial use is transferred short distances through relatively narrow-diameter pipes at pressures of just a few hundred psi. For this purpose, carbon steel has been the principal material of choice for pipeline construction; however, cast iron, copper, various plastics—e.g., polyvinyl chloride (PVC) and high-density polyethylene (HDPE)—have also been used, particularly to transfer the gas over short distances.

A major concern for future, high-capacity hydrogen pipelines is long-term durability at internal gas pressures greater than or equal to 500 psi. It is well known that, at these pressures, carbon steels are susceptible to hydrogen embrittlement and cracking, and while the effects of high-pressure hydrogen on plastics are not well known, significant long-term negative impacts on these materials are also a real possibility. Hydrogen embrittlement of metals is generally manifested by surface cracking, crack propagation, decreases in tensile strength, loss of pipeline ductility, and reduced burst-pressure rating. This degradation can lead to premature failure of one or more segments of a pipeline, resulting in leakage of gas—or in extreme circumstances, bursting of a pipe. In view of these risks, it is not surprising that qualification of pipeline materials for hydrogen service at high gas pressures is currently an area of active research and development.

It has been suggested recently that many of the pipeline cost, weight, welding and joining, repair, and safety issues associated with carbon steel can be resolved by switching to fiber-reinforced polymer (FRP) materials. The issues and challenges for adapting existing FRP pipeline technology to hydrogen service at pressures above about 500 psi are: evaluating polymeric materials for hydrogen containment, compatibility, and prolonged pressure-cycling; identifying methods for profitable manufacture of pipes with inside diameters greater than four inches; weighing the options for on-site pipeline fabrication, joining, and repair; determining the availability of sensor technologies for measuring gas temperature, pressure, and flow rate in real time; and writing the necessary codes and standards to meet the requirements of local, state, and federal regulatory agencies. In this regard, it is noteworthy that the use of spoolable FRP pipe—or better yet, FRP pipe continuously fabricated in the field—would greatly simplify installation of long-distance hydrogen pipelines, thereby lowering overall costs of pipeline construction. FRP pipes can withstand large strains, which allows them to be “bent” easily and emplaced as a continuous, seamless monolith. Finally, because FRP pipes can be manufactured with sensors embedded in their walls, it is likely that long-distance, large-diameter FRP pipelines built for hydrogen transmission could be operated as “smart structures.” This would enable lifetime performance-monitoring of the pipeline, which could result in substantial safety enhancements and long-term cost savings.

### SUMMARY

According to the teachings of this disclosure, the hydrogen-containment efficacies of hollow structures of all shapes, sizes, and wall thicknesses can be greatly enhanced by creating multiple “equilibrium” (steady-state) and kinetic barriers to hydrogen permeation. More specifically, the technologies disclosed herein relate to diffusive hydrogen flux across the inner and outer surfaces of containers, or layers within those containers (“interlayers”), formed from one or more solid or liquid materials. Containers for hydrogen gas constructed from solid materials often fail to prevent, or adequately control, release of enclosed hydrogen gas. In addition, permeation of hydrogen into a solid material can damage its microstructure and reduce its mechanical strength. The technologies described below resolve these problems in two principal ways. First, one or more layers of polymeric, metallic (e.g., metal and metal alloy), metal oxide, and/or liquid material(s) may be used to create one or more supplementary, or enhanced, barriers to diffusion of hydrogen gas. Second, to augment creation of one or more supplementary or enhanced barriers to egress of hydrogen from a container, the exiting gas can be captured before it escapes to the surrounding environment.

The hydrogen containment and recovery practices inherent in the specific example embodiments described herein may be applied to the construction of enclosures and passageways of many different geometrical forms, e.g., planar, spherical, cylindrical, etc. However, tubes of all types, and especially large pipes, are of particular interest, as they can be used to transmit and/or store gaseous hydrogen. For pipes and pipelines, potential applications of the technologies disclosed herein include: (i) use of one or more layers of homogeneous or laminated polymeric material, and (optionally) solid metal(s), e.g., copper (Cu), aluminum (Al), or stainless steel, each metal with or without oxidized inner/outer surfaces (see FIGS. 1-3) and/or liquid(s), to create multiple equilibrium and kinetic barriers to hydrogen diffusion; (ii) in special circumstances, physical separation of gaseous hydrogen from one or more static or flowing liquid interlayers; and (iii) when necessary, capture and recovery of escaping gaseous hydrogen at the points in a pipeline system where connections are made (see FIGS. 4-6).

According to the teachings of this disclosure, a structure for transferring and/or storing hydrogen gas may be lined or coated with, or constructed from, layered polymer/metal/metal oxide material. Often, two or more layers of one or more of these three materials will be pressed together tightly to form one or more thicker, composite layers. This layering/interlayering of materials impedes diffusive hydrogen flux in three ways. First, it automatically creates “contact resistance” to hydrogen flux, a phenomenon whereby diffusion of gaseous hydrogen is deterred kinetically by abrupt changes in microstructure at the boundaries of the individual layers in the multi-layer structure. Second, permeation of gaseous hydrogen through the composite structure slows when the gas reaches the metal layer(s)/interlayer(s), because the equilibrium solubility of hydrogen in, and the steady-state rate of hydrogen diffusion through, the metallic material will be, respectively, much lower, and much slower, than in the non-metallic material. Third, when gaseous hydrogen travels through a layer of metallic material sandwiched between two layers of non-metallic material, the structural state of the gas is forced to switch from diatomic (in the inner layer of non-metallic material), to atomic (in the metallic material), back to diatomic (in the outer layer of non-metallic material)—an alternation that is kinetically constrained by itself, but in addition, is further restrained physicochemically by the sharp discontinuities in solid-state microstructure that occur at the boundaries between the metallic and non-metallic layers.

According to the teachings of this disclosure, a structure for transferring and/or storing hydrogen gas may be a three-layer, composite configuration consisting of an inner layer of polymeric material (e.g., high-density polyethylene, HDPE), an interlayer of metal (possibly with its inner and/or outer surfaces oxidized to enhance hydrogen-containment performance), and an outer layer of polymeric material (e.g., HDPE) (FIGS. 2 and 3). In addition to its structural simplicity, this arrangement of layers substantially protects the metal±metal oxide interlayer from mechanical abrasion and chemical attack.

According to the teachings of this disclosure, a structure for transferring and/or storing hydrogen gas may include one or more gas-tight covers placed over one or more parts of the structure (FIGS. 4-6), or a single gas-tight cover may enclose the entire structure. Hydrogen gas exiting the structure is captured in the gas-tight cover(s) before it can escape to the surrounding environment. The gaseous hydrogen that accumulates in the interior of a cover is removed through one or more ports in the cover. Employing this strategy for hydrogen “recovery,” escape of gaseous hydrogen from containers is managed adequately rather then prevented completely.

According to the teachings of this disclosure, a structure for transferring and/or storing hydrogen gas may include one or more interlayers of a (largely) stagnant or flowing liquid, which either: (i) affords the opportunity to use a “material of construction” that is much cheaper and much more flexible than one or more layers of polymer/metal/metal oxide; (ii) diverts the solid/liquid-state diffusion of hydrogen, or its buoyant ascent as a separate gas phase, toward one or more predetermined “points of egress”; or (iii) in the case of pipeline transfer of hydrogen gas from sites of electrolytic generation to remote destinations where it is used as a fuel, enables reverse flow of either high-purity water or an aqueous solution (see FIG. 7).

According to the teachings of this disclosure, one or more pipes with one or more polymer/metal±metal oxide layers or interlayers may be used primarily to store hydrogen gas. When the goal is to store large masses of gaseous hydrogen for stationary (“offboard”) applications, tightly packed sets of the pipes may be placed in hydrogen “warehouses” or “silos” that provide seasonally firmed supplies of the gas to local or city-gate markets.

It is contemplated and within the scope of this disclosure that the various embodiments claimed herein may be utilized for the transportation and/or storage of high-purity hydrogen and/or hydrogen-bearing gas, e.g., hydrogen gas mixed with natural gas and/or biomethane (hereinafter collectively referred to as “gaseous hydrogen”) so as to make the best use of the existing energy infrastructure.

### BRIEF DESCRIPTION OF THE DRAWINGS

A more complete understanding of the present disclosure thereof may be acquired by referring to the following description taken in conjunction with the accompanying drawings wherein:

FIG. 1 is an x-y plot of the hydrogen permeabilities of certain metals plotted as a function of inverse temperature;

FIGS. 2 and 3 illustrate a transverse cross-section and a longitudinal cross-section, respectively, of a multi-layered polymer/metal pipe, with or without a layer of metal oxide on the inner and/or outer surfaces of the metallic layer, according to specific example embodiments of this disclosure;

FIG. 4 illustrates a schematic illustration of a prior technology pipe-to-pipe connector used by Fiberspar (www.fiberspar.com);

FIG. 5 illustrates a schematic diagram of a longitudinal cross-section/projection of a hydrogen-capture system, according to a specific example embodiment of this disclosure;

FIG. 6 illustrates a schematic diagram of a longitudinal cross-section/projection of a hydrogen-capture system, according to another specific example embodiment of this disclosure; and

FIG. 7 illustrates a schematic diagram of a longitudinal cross-section of a multi-layered, polymer/liquid interlayered pipe in which hydrogen gas and liquid water flow in opposite directions, according to yet another specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of example embodiments are schematically illustrated. Like elements in the drawings will be represented by like numbers, and similar elements will be represented by like numbers with a different lower case letter suffix.

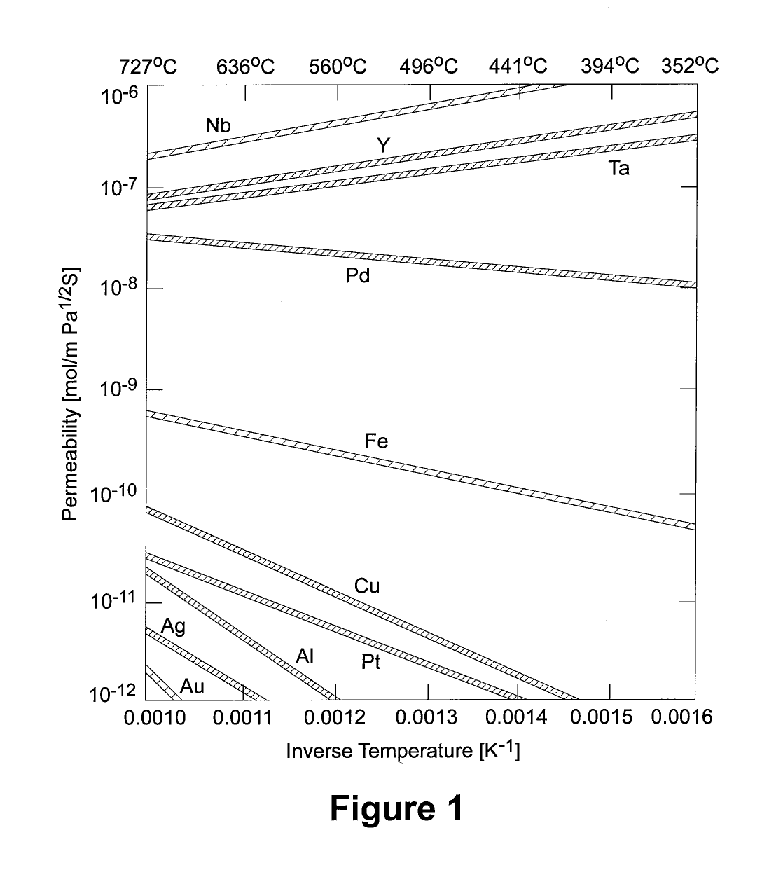

Referring to FIG. 1, depicted is an x-y graph of the hydrogen permeabilities of certain metals plotted as a function of inverse temperature. The certain metals shown in the graph of FIG. 1 are: niobium (Nb), yttrium (Y), tantalum (Ta), palladium (Pd), iron (Fe), copper (Cu), platinum (Pt), aluminum (Al), silver (Ag), and gold (Au). The curve for iron (Fe) is broadly representative of measured hydrogen permeabilities for carbon and stainless steels.

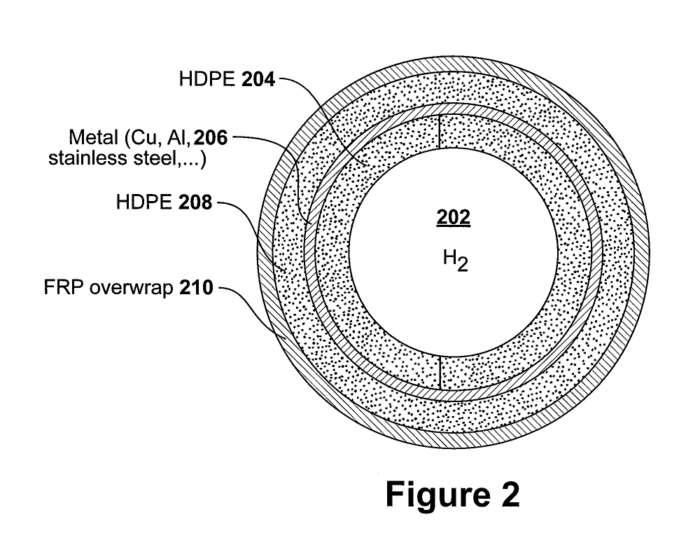

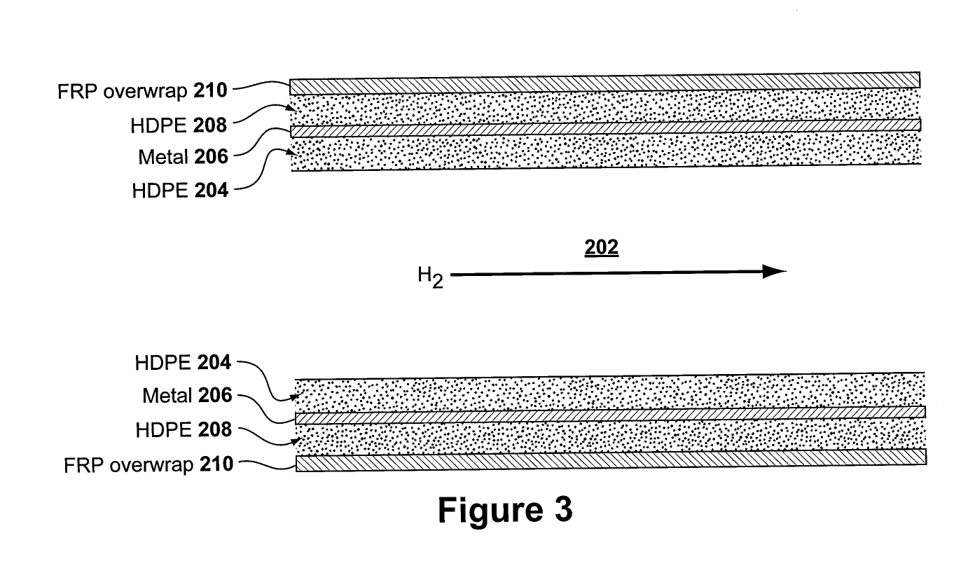

Referring to FIGS. 2 and 3, depicted is a transverse cross-section and a longitudinal cross-section, respectively, of a multi-layered polymer/metal pipe, with or without a layer of metal oxide on the inner and/or outer surfaces of the metallic layer, according to specific example embodiments of this disclosure. The diameter of the hollow part of the pipe, and the thicknesses of the individual layers in its wall, are schematically shown for purposes of illustration and do not necessarily represent actual thicknesses thereof.

According to the teachings of this disclosure, diffusive flux of hydrogen gas 202 through the wall of the pipe is impeded by two or more layers of a polymeric/metallic/metal oxide material, e.g., high-density polyethylene (HDPE) 204 and metal 206, which may be pressed together tightly to form one or more thicker, composite layers, e.g., HDPE 204 and metal 206, and metal 206 and HDPE 208, etc., (also fiber-reinforced polymer (FRP) 210).

It is contemplated and within the scope of this disclosure that to further deter hydrogen diffusive flux, the inner and/or outer surfaces of the metallic layer(s) may be oxidized prior to, during, or after creation of the polymer/metal structure. Because mass transfer (diffusion) of hydrogen 202 across the boundaries of the layers will proceed at finite rates, it is expected that gas concentration will be discontinuous at the boundaries between individual (polymer/metal/metal oxide) layers. The magnitudes of these discontinuities will depend on, first, the interfacial mass-transfer coefficients for the composite medium, and second, the equilibrium constants that represent the distribution of hydrogen 202 between contiguous layers of contrasting compositions. These observations undergrid the concept of “contact resistance,” which refers to the degree to which diffusion of hydrogen gas is impeded kinetically by abrupt changes in microstructure at the boundaries of the individual layers in the multi-layer material. In this regard, a laminated polymer/metal/metal oxide composite is of particular interest because the modes of hydrogen dissolution in the materials differ significantly. In polymers and metal oxides, hydrogen dissolves in the molecular (diatomic) state, whereas in metals, hydrogen molecules split into hydrogen atoms upon dissolution—reverting to the diatomic state only upon subsequent migration into a non-metallic material. If the latter substance is a polymer or metal oxide in which hydrogen is meagerly soluble, and if the polymer/metal/metal oxide interface is made sufficiently sharp by substantial compression, then a good possibility exists that hydrogen diffusion will be impeded due to the strongly nonlinear boundary conditions that are automatically created by this layering.

According to the teachings of this disclosure, because metals such as Cu, Al, and stainless steel have very low “equilibrium” (steady-state) hydrogen permeabilities (see FIG. 1)—a three-layer polymer/metal±metal oxide/polymer composite has a high potential for being especially effective in deterring hydrogen diffusion. For example, when the wall of a composite pipe (e.g., see FIGS. 2 and 3) becomes saturated with hydrogen at a constant internal hydrogen pressure—i.e., reaches “equilibrium”/steady-state conditions—the thicknesses of the individual layers are no longer a factor in determining the overall rate of hydrogen flux. Thus, in this circumstance, a thin metal±metal oxide interlayer is as effective as a thick metal±metal oxide interlayer in slowing the overall rate of hydrogen escape through the wall of the pipe.

In addition, by virtue of its structural simplicity and ease of fabrication, a three-layer polymer/metal±metal oxide/polymer structure might prove to be a low-cost alternative to barriers consisting of finely-laminated polymers. A particularly attractive advantage of this embodiment is that the inner and outer layers of polymeric material will substantially protect the metal±metal oxide interlayer from mechanical abrasion and chemical attack. This can be important when the interior metallic layer is a foil formed from a metal that is relatively soft, or easily corroded (e.g., aluminum or annealed, oxygen-free copper).

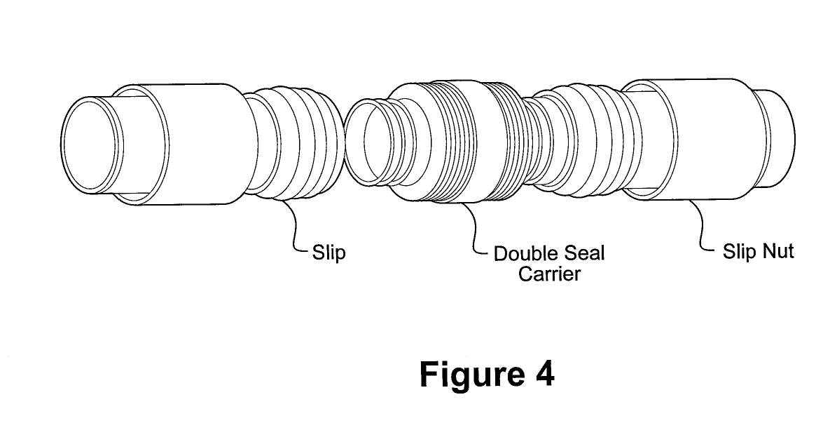

Referring to FIG. 4, depicted is a schematic illustration of a prior technology pipe-to-pipe connector used by Fiberspar (www.fiberspar.com). Connectors of this and other kinds are very effective in containing oil and natural gas, but are unlikely to be completely “gas-tight” in hydrogen pipelines.

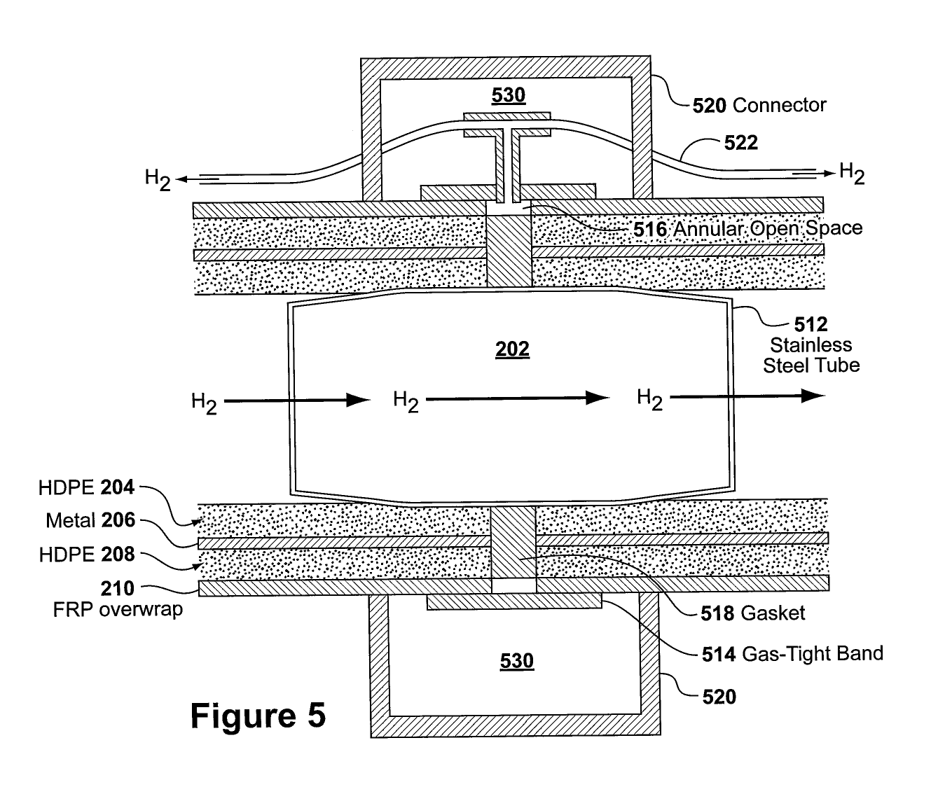

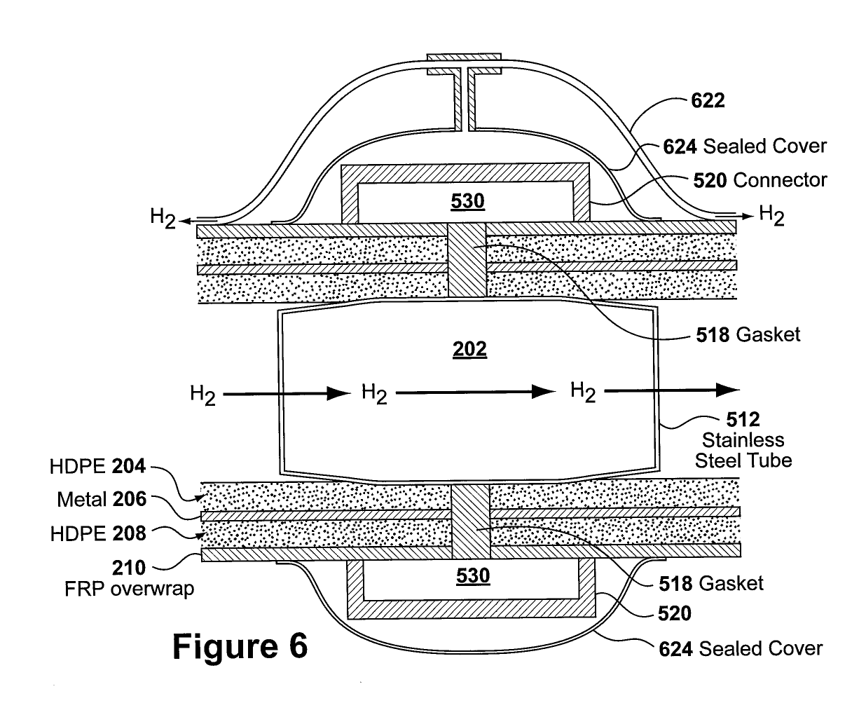

Referring to FIGS. 5 and 6, depicted are schematic diagrams of longitudinal cross-sections/projections of a hydrogen-capture system, according to specific example embodiments of this disclosure. Enhanced overall containment of pipeline-transmitted hydrogen gas may be achieved by capturing the hydrogen that is leaking from the pipeline where pipe connections are made. An example is illustrated schematically in FIG. 5, where it can be seen that diffusing hydrogen gas released into the sealed annular space 516 surrounding a gasket 518 placed between two interconnected sections of polymer/metal/metal oxide pipe is readily removed through a small port connected to a tee and the capillary tubes 522 (see the top of FIG. 5). In FIG. 6, the enclosed space within the sealed cover 624 is used to collect the hydrogen gas diffusing (mainly) through gasket 618. This “released” hydrogen gas is removed through a small port connected to a tee and the capillary tubes 622 (see the top of FIG. 6). Using these and other similar structural configurations, escape of hydrogen through pipe-to-pipe and “end” connections—if found to be a problem—can be readily managed, thereby eliminating the need to completely prevent such loss. This observation indicates that new connecting technologies will not be required for safe and cost-effective field deployment of multi-layered polymer and polymer/metal±metal oxide hydrogen pipes and pipelines.

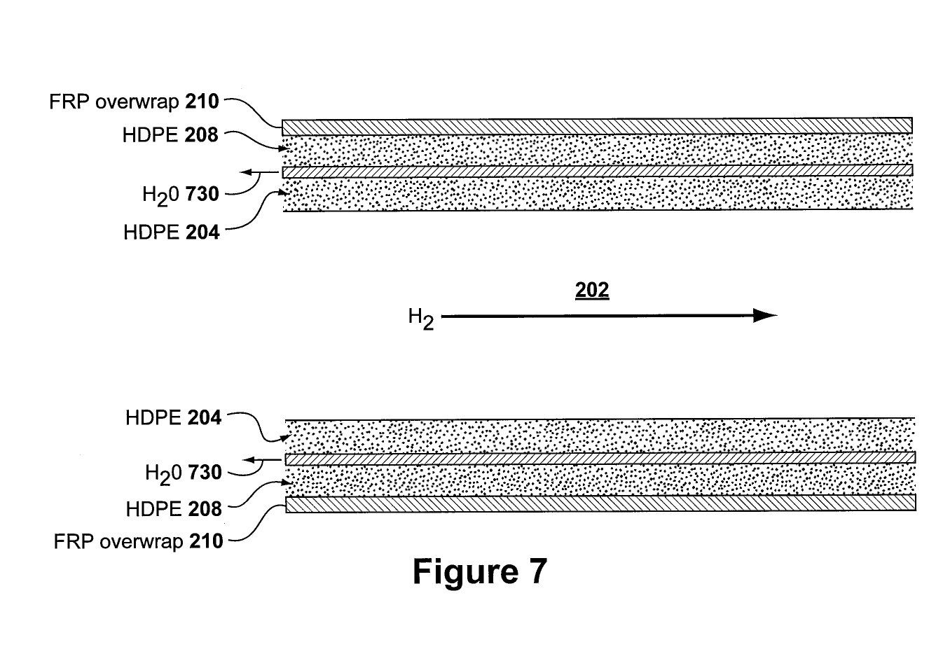

Referring to FIG. 7, depicted is a schematic diagram of a longitudinal cross-section of a multi-layered, polymer/liquid interlayered pipe in which hydrogen gas and liquid water flow in opposite directions, according to yet another specific example embodiment of this disclosure. This embodiment has multiple forms that follow from three related objectives, which are: first, to achieve an enhanced ability to prevent hydrogen loss; second, to separate and capture escaping hydrogen gas by diverting its solid/liquid-state diffusion, or its buoyant ascent, toward one or more designated “points of egress,” and third, in the case of pipeline transfer of hydrogen gas from sites of electrolytic generation to remote destinations where it is used as a fuel, to permit reverse flow of either high-purity water or an aqueous solution.

In the first manifestation, one or more layers of stagnant, or nearly stagnant, liquid(s) 730, in which hydrogen is sparingly soluble, is used to decrease the overall rate at which gaseous hydrogen escapes from the container. There is little or no net flow of liquid 730 (H₂O in FIG. 7) into or out of the annular space it occupies. In addition, no attempt is made to separate and capture the hydrogen gas 202 that diffuses into and through the liquid 730, or which exsolves temporarily, forming a separate “free-vapor phase” (perhaps due to cycling of temperature and/or pressure). The liquid(s) 730 used might be, for example, one or more aqueous solutions that contain NaCl (ordinary table salt) and/or CaCl₂. However, it is likely that hydrogen gas will be “salted out” more effectively using one or more salts that dissolve as doubly or triply charged ions. Aluminum sulfate is one such salt. This method of hydrogen containment is technically and economically appealing because loss of gaseous hydrogen is diminished using a material that is much cheaper and much more flexible than a layer of polymeric/metallic/metal oxide material.

The second manifestation leverages the relatively rapid rates of hydrogen diffusion through many types of liquids (e.g., high-purity water and aqueous solutions) compared to polymeric materials. The solubility of hydrogen in polymeric materials is high compared to many liquids. Significantly, however, diffusive flux of gaseous hydrogen is generally much faster in liquids than in polymers. Therefore, hydrogen-permeable membranes (not shown), or one or more valves (not shown), connected to one or more liquid interlayers in the multi-layer barrier material (e.g., 730 in FIG. 7) can be used to “tap off” substantial masses of the gas (not shown), thus reducing the total amount of hydrogen that escapes through the outermost layer of the multi-layer barrier system.

The third manifestation affords enhanced containment of escaping hydrogen gas by trapping it in one or more flowing liquid interlayers, and transporting it to one or more distal locations in the barrier system where it is either consumed (e.g., used as a fuel), or reinjected into the structure from whence it came (e.g., see FIG. 7). In the liquid interlayer(s), the hydrogen will be mainly transported either: (i) as a dissolved gas, (ii) as entrained bubbles of varying sizes, or (iii) as a continuous “headspace” gas overlying subjacent liquid material. Clearly, this capture, transport, and use/recovery operation decreases the mass of hydrogen gas that ultimately diffuses through the outermost layer(s) of the structure.

According to the teachings of this disclosure, the polymer/metal±metal oxide-interlayered FRP pipes disclosed hereinabove for the transmission and distribution of gaseous hydrogen may also be used to store hydrogen gas in bulk quantities. The latter result may be achieved by building hydrogen “warehouses” or “silos” (not shown) filled with tightly packed aggregates of polymer/metal±metal oxide-interlayered FRP pipes (e.g., see FIGS. 2 and 3), which may be arranged in, for example, but are not limited to, basic geometric configurations such as: (i) horizontal rows of parallel pipes of equal/near-equal length, stacked vertically to a height close to the ceiling of the warehouse, (ii) rows or circular/near-circular bundles of vertically oriented parallel pipes of equal/near-equal length, reaching to a height close to the ceiling of the warehouse/silo; and (iii) a group of axially concentric (or nearly so) coiled pipes with outside pipe diameters decreasing progressively from the outermost coil to the innermost coil—e.g., 36-inch O.D. pipe for the outermost coil progressing to 4-inch O.D. pipe for the innermost coil. It is contemplated and within the scope of this disclosure that other configurations may be used depending upon the storage shape/area/volume available. These other configurations would be readily apparent to those having ordinary skill in the art of gas storage and having the benefit of the teachings of this disclosure.

For each configuration, suitable “superstructures” (not shown) may be erected to provide adequate structural support for the pipes, and to hold them in place. In configuration (i) discussed in the previous paragraph, individual pipes may be pulled into, and out of, troughs (fabricated, e.g., from steel, concrete, etc.) using procedures similar to those currently applied to pull polymer pipes through the interiors of abandoned steel pipelines. For the coiled configuration (see (iii) in the previous paragraph), a “basement” beneath the storage facility may be needed to allow individual pipes to be pulled into, and out of, a wound position. For each configuration, the ability to remove a pipe enables servicing or replacement as required. The need for such repair or substitution would be indicated, for example, by unacceptably fast leakage of hydrogen gas from either one or more pipes in the warehouse/silo, and/or from one or more of the pipe-to-pipe or end connections made to those storage pipes. Such leaks could be easily detected if the open space around the storage pipes in the warehouse/silo was filled to capacity (or nearly so) with a liquid (e.g., water) at either atmospheric or elevated pressure. Leaking hydrogen gas would be manifested by one or more trains of bubbles of that gas rising toward the top surface of the liquid. The “captured” hydrogen that accumulates at the top of the column/body of liquid, beneath the ceiling of the warehouse/silo, would be drawn off to prevent excessive buildup of the gas, which would be a safety hazard. The idea behind using pressurized liquid to detect leakage of hydrogen gas by the method just described is that differential pressure across the walls of the storage pipes would be diminished to an extent equivalent to the pressure of the liquid. For example, if the hydrogen gas stored in the pipes is at a pressure of 2000 psi, and the liquid surrounding the pipes is at a pressure of 1000 psi, then the differential pressure across the walls of the pipes would be 2000 psi−1000 psi=1000 psi, which is approximately half of the differential pressure that the walls of the storage pipes would be required to withstand if the pressure of the surrounding liquid was atmospheric (˜15 psi). This lowering of differential pressure might make the pipes much more durable than they would otherwise be. After these and other options for bulk warehouse/silo hydrogen storage have been properly weighed and tested technologically, it is reasonable to expect that the polymer/metal±metal oxide storage pipes will have service lifetimes as long as 50 years, depending mainly on susceptibility to the potentially damaging effects of prolonged exposure to high-pressure hydrogen, and to hydrogen pressure-cycling.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

1. An apparatus for containing hydrogen gas, comprising:
a first polymeric material formed to enclose the hydrogen gas; and
a metallic material formed to enclose the first polymeric material.

2. The apparatus according to claim 1, further comprising a fiber-reinforced polymeric material formed to enclose the metallic material.

3. The apparatus according to claim 1, further comprising a second polymeric material formed to enclose the metallic material.

4. The apparatus according to claim 3, further comprising a fiber-reinforced polymeric material formed to enclose the second polymeric material.

5. The apparatus according to claim 1, further comprising a metal oxide formed on at least one surface of the metallic material.

6. The apparatus according to claim 5, further comprising a second polymeric material formed to enclose the metallic material and the metal oxide.

7. The apparatus according to claim 1, wherein the first polymeric material and the metallic material are formed into a pipe for transmission of the hydrogen gas therethrough.

8. The apparatus according to claim 1, wherein the first polymeric material and the metallic material are formed into a tube for transmission of the hydrogen gas therethrough.

9. The apparatus according to claim 1, wherein the first polymeric material and the metallic material are formed into a container for storage of the hydrogen gas therein.

10. The apparatus according to claim 1, wherein the first polymeric material and the metallic material are formed into a plurality of pipes for storage of the hydrogen gas therein.

11. The apparatus according to claim 1, wherein the first polymeric material and the metallic material are formed into a plurality of tubes for storage of the hydrogen gas therein.

12. The apparatus according to claim 3, wherein the first polymeric material, the metallic material and the second polymeric material are formed into a pipe for transmission of the hydrogen gas therethrough.

13. The apparatus according to claim 3, wherein the first polymeric material, the metallic material and the second polymeric material are formed into a plurality of pipes for storage of the hydrogen gas therein.

14. The apparatus according to claim 4, wherein the first polymeric material, the metallic material, the second polymeric material and the fiber-reinforced polymeric material are formed into a pipe for transmission of the hydrogen gas therethrough.

15. The apparatus according to claim 4, wherein the first polymeric material, the metallic material, the second polymeric material and the fiber-reinforced polymeric material are formed into a plurality of pipes for storage of the hydrogen gas therein.

16. The apparatus according to claim 1, wherein the first polymeric material is high-density polyethylene.

17. The apparatus according to claim 3, wherein the second polymeric material is high-density polyethylene.

18. The apparatus according to claim 1, wherein the metallic material has low hydrogen permeability.

19. The apparatus according to claim 18, wherein the metallic material is selected from the group consisting of niobium (Nb), yttrium (Y), tantalum (Ta), palladium (Pd), iron (Fe), copper (Cu), platinum (Pt), aluminum (Al), silver (Ag), and gold (Au).

20. The apparatus according to claim 18, wherein the metallic material is stainless steel.

21. The apparatus according to claim 18, wherein the metallic material is carbon steel.

22. The apparatus according to claim 18, wherein the metallic material is a metal alloy.

23. The apparatus according to claim 22, wherein the metal alloy is a copper alloy.

24. The apparatus according to claim 22, wherein the metal alloy is an aluminum alloy.

25. The apparatus according to claim 22, wherein the metal alloy is a copper and aluminum alloy.

26. The apparatus according to claim 1, wherein the first polymeric material and the metallic material are laminated together.

27. The apparatus according to claim 2, wherein the first polymeric material, the metallic material and the fiber-reinforced polymeric material are laminated together.

28. The apparatus according to claim 3, wherein the first polymeric material, the metallic material and the second polymeric material are laminated together.

29. The apparatus according to claim 4, wherein the first polymeric material, the metallic material, the second polymeric material and the fiber-reinforced polymeric material are laminated together.

30. The apparatus according to claim 1, wherein the first polymeric material comprises a plurality of polymeric material layers.

31. The apparatus according to claim 3, wherein the second polymeric material comprises a plurality of polymeric material layers.

32. A system for conveying gaseous hydrogen, said system comprising:
at least one multi-layer composite cylinder having a hollow core through which gaseous hydrogen passes; wherein
the at least one multi-layer composite cylinder comprises
at least two layers of polymeric material, and
at least one layer of metallic material between the at least two layers of polymeric material.

33. The system according to claim 32, further comprising fiber-reinforcement of an outer layer of the at least two layers of polymeric material.

34. The system according to claim 32, further comprising high-strength steel reinforcement of an outer layer of the at least two layers of polymeric material.

35. The system according to claim 32, wherein the at least two layers of polymeric material and the at least one layer of metallic material are laminated together.

36. The system according to claim 32, further comprising a metal oxide formed on at least one surface of the at least one layer of metallic material.

37. The system according to claim 32, further comprising at least one layer of liquid material between the at least two layers of polymeric material.

38. The system according to claim 37, wherein the at least one layer of liquid material flows within at least one annular space located between the at least two layers of polymeric material.

39. The system according to claim 38, wherein the at least one layer of liquid material flows into an inlet end and out of an outlet end of the at least one multi-layer composite cylinder.

40. The system according to claim 39, wherein the least one layer of liquid material substantially captures the gaseous hydrogen that leaks through a one or more of the at least two layers of polymeric material and is carried out by the flowing at least one layer of liquid material.

41. The system according to claim 39, wherein the least one layer of liquid material substantially captures the gaseous hydrogen that leaks through the at least one layer of metallic material and is carried out by the flowing at least one layer of liquid material.

42. The system according to claim 40, wherein the captured gaseous hydrogen is absorbed into the least one layer of liquid material.

43. The system according to claim 40, wherein the captured gaseous hydrogen contained in the least one layer of liquid material is in a gaseous state.

44. The system according to claim 37, wherein the liquid material is high-purity water.

45. The system according to claim 37, wherein the liquid material is an aqueous solution.

46. The system according to claim 45, wherein the aqueous solution comprises a mixture of water (H₂O) and a salt.

47. The system according to claim 46, wherein the salt is selected from the group consisting of NaCl, CaCl₂, and aluminum sulfate.

48. The system according to claim 32, wherein a plurality of the at least one multi-layer composite cylinders are coupled together to form a pipeline for conveying the gaseous hydrogen.

49. The system according to claim 48, further comprising a substantially gas tight band at each location where the plurality of the at least one multi-layer composite cylinders are coupled together, wherein the gaseous hydrogen that leaks through any of these locations is collected in annular spaces within the substantially gas tight bands.

50. The system according to claim 48, further comprising a substantially gas tight cover at each location where the plurality of the at least one multi-layer composite cylinders are coupled together, wherein the gaseous hydrogen that leaks through any of these locations is collected in the substantially gas tight covers.

51. The system according to claim 49, further comprising at least one gas port in each of the substantially gas tight bands for conveying away the gaseous hydrogen collected in the annular spaces.

52. The system according to claim 50, further comprising at least one gas port in each of the substantially gas tight covers for conveying away the gaseous hydrogen collected in the substantially gas tight covers.

53. The system according to claim 51, wherein the gaseous hydrogen collected in the annular spaces is used for fuel.

54. The system according to claim 52, wherein the gaseous hydrogen collected in the substantially gas tight covers is used for fuel.

55. A system for conveying and reclaiming gaseous hydrogen, said system comprising:
at least one multi-layer composite cylinder having a hollow core through which gaseous hydrogen passes; wherein
the at least one multi-layer composite cylinder comprises
at least two layers of polymeric material, and
at least one layer of liquid material between the at least two layers of polymeric material.

56. The system according to claim 55, further comprising fiber-reinforcement of an outer layer of the at least two layers of polymeric material.

57. The system according to claim 55, further comprising high-strength steel reinforcement of an outer layer of the at least two layers of polymeric material.

58. The system according to claim 55, wherein the least one layer of liquid material substantially captures the gaseous hydrogen that leaks through a one or more of the at least two layers of polymeric material.

59. The system according to claim 58, wherein the captured gaseous hydrogen is absorbed into the least one layer of liquid material.

60. The system according to claim 58, wherein the captured gaseous hydrogen contained in the at least one layer of liquid material is in a gaseous state.

61. The system according to claim 55, wherein the at least one layer of liquid material flows within an annular space located between the at least two layers of polymeric material.

62. The system according to claim 55, wherein the at least one layer of liquid material flows into an inlet end and out of an outlet end of the at least one multi-layer composite cylinder.

63. The system according to claim 62, wherein the gaseous hydrogen that passes through a wall of the at least one of the at least two layers of polymeric material is carried out with the flow of the at least one layer of liquid material.

64. The system according to claim 63, wherein the gaseous hydrogen that passes through the wall of the at least one of the at least two layers of polymeric material is absorbed into the at least one layer of liquid material and is carried out with the flow thereof.

65. The system according to claim 63, wherein the gaseous hydrogen that passes through the wall of the at least one of the at least two layers of polymeric material returns to a gaseous state in the at least one layer of liquid material and is carried out with the flow thereof.

66. The system according to claim 55, wherein the at least one layer of liquid material is comprised of at least one layer of high-purity water.

67. The system according to claim 55, wherein the at least one layer of liquid material is comprised of at least one layer of an aqueous solution.

68. The system according to claim 67, wherein the at least one layer of the aqueous solution comprises a mixture of water (H₂O) and a salt.

69. The system according to claim 68, wherein the salt is selected from the group consisting of NaCl, CaCl₂, and aluminum sulfate.

70. The system according to claim 55, wherein a plurality of the at least one multi-layer composite cylinders are coupled together to form a pipeline for conveying the gaseous hydrogen.

71. The system according to claim 70, further comprising a substantially gas tight band at each location where the plurality of the at least one multi-layer composite cylinders are coupled together, wherein the gaseous hydrogen that leaks through any of these locations is collected in annular spaces within the substantially gas tight bands.

72. The system according to claim 70, further comprising a substantially gas tight cover at each location where the plurality of the at least one multi-layer composite cylinders are coupled together, wherein the gaseous hydrogen that leaks through any of these locations is collected in the substantially gas tight covers.

73. The system according to claim 71, further comprising at least one gas port in each of the substantially gas tight bands for conveying away the gaseous hydrogen collected in the annular spaces.

74. The system according to claim 72, further comprising at least one gas port in each of the substantially gas tight covers for conveying away the gaseous hydrogen collected in the substantially gas tight covers.

75. The system according to claim 73, wherein the gaseous hydrogen collected in the annular spaces is used for fuel.

76. The system according to claim 74, wherein the gaseous hydrogen collected in the substantially gas tight covers is used for fuel.

77. A hydrogen storage system, said system comprising:
a plurality of multi-layer composite cylinders, wherein each one of the plurality of multi-layer composite cylinders has a hollow core for storing gaseous hydrogen and comprises at least two layers of polymeric material.

78. The hydrogen storage system according to claim 77, further comprising at least one layer of metallic material between the at least two layers of polymeric material for at least one of the plurality of multi-layer composite cylinders.

79. The hydrogen storage system according to claim 77, further comprising at least one layer of liquid material within at least one annular space located between the at least two layers of polymeric material of each one of the plurality of multi-layer composite cylinders.

80. The hydrogen storage system according to claim 77, wherein the plurality of multi-layer composite cylinders are arranged as a gaseous hydrogen warehouse.

81. The hydrogen storage system according to claim 77, wherein the plurality of multi-layer composite cylinders are arranged as a gaseous hydrogen silo.

82. The hydrogen storage system according to claim 77, wherein the plurality of multi-layer composite cylinders are a plurality of multi-layer composite pipes coupled together.

83. The hydrogen storage system according to claim 82, wherein the plurality of multi-layer composite pipes are substantially the same length and are placed substantially parallel to one another with their long axes oriented in horizontal layers that are stacked vertically.

84. The hydrogen storage system according to claim 82, wherein the plurality of multi-layer composite pipes are substantially the same length and are placed substantially parallel to one another in substantially circular bundles with their long axes oriented vertically.

85. The hydrogen storage system according to claim 82, wherein the plurality of multi-layer composite pipes are coiled, the plurality of coiled multi-layer composite pipes having long axes that are substantially concentric.

86. The hydrogen storage system according to claim 85, wherein the plurality of coiled multi-layer composite pipes have outside diameters that decrease progressively from an outermost coil to an innermost coil.

87. The hydrogen storage system according to claim 80, wherein the gaseous hydrogen warehouse is coupled to a gaseous hydrogen pipeline system for either transmitting or distributing pressurized hydrogen gas.

88. The hydrogen storage system according to claim 81, wherein the gaseous hydrogen silo is coupled to a gaseous hydrogen pipeline system for either transmitting or distributing pressurized hydrogen gas.

89. The hydrogen storage system according to claim 77, further comprising a liquid surrounding the plurality of multi-layer composite cylinders.

90. The hydrogen storage system according to claim 77, further comprising a pressurized liquid surrounding the plurality of multi-layer composite cylinders for decreasing pressure gradients between the hollow cores and outer surfaces thereof.

91. The hydrogen storage system according to claim 78, further comprising a pressurized liquid surrounding the plurality of multi-layer composite cylinders for decreasing pressure gradients between the hollow cores and outer surfaces thereof.

92. The hydrogen storage system according to claim 79, further comprising a pressurized liquid surrounding the plurality of multi-layer composite cylinders for decreasing pressure gradients between the hollow cores and outer surfaces thereof.

93. The hydrogen storage system according to claim 89, wherein the liquid is selected from the group consisting of high-purity water, hydrogen-bearing water, and hydrogen-saturated water.

94. The hydrogen storage system of claim 89, wherein the pressure of the liquid surrounding the plurality of multi-layer composite cylinders tracks the pressure of the hydrogen gas in the plurality of multi-layer composite cylinders.

95. The hydrogen storage system of claim 94, wherein the pressure of the liquid surrounding the plurality of multi-layer composite cylinders is substantially the same pressure as the hydrogen gas in the plurality of multi-layer composite cylinders.

96. The hydrogen storage system of claim 79, wherein the at least one layer of liquid material captures the hydrogen gas that leaks from the hollow cores.

97. The hydrogen storage system of claim 96, wherein the captured hydrogen gas is absorbed into the at least one layer of liquid material.

98. The hydrogen storage system of claim 96, wherein the captured hydrogen gas has returned to a gaseous state.

99. The hydrogen storage system according to claim 78, further comprising a metal oxide formed on at least one surface of the at least one layer of metallic material.
